(19) United States
(12) Patent Application Publication
(10) Pub. No.: US 2025/0134761 A1
(43) Pub. Date: May 1, 2025

(54) MUSCLE PASSIVE HAPTIC REHABILITATION SYSTEMS AND METHODS FOR TREATING NEUROLOGICAL DYSFUNCTIONS

(71) Applicant: The Board of Trustees of the Leland Stanford Junior University, Stanford, CA (US)

(72) Inventors: Caitlyn E. Seim, Palo Alto, CA (US); Allison Mariko Okamura, Mountain View, CA (US)

(21) Appl. No.: 18/946,774

(22) Filed: Nov. 13, 2024

Related U.S. Application Data
(63) Continuation of application No. PCT/US2023/023122, filed on May 22, 2023.
(60) Provisional application No. 63/344,630, filed on May 22, 2022.

(51) Int. Cl. A61H 23/02

(52) U.S. Cl. CPC A61H 23/02; A61H 2201/0153; A61H 2201/0157; A61H 2201/1207; A61H 2201/1638; A61H 2201/165; A61H 2201/50; A61H 2205/067; A61H 2205/106; A61H 2205/12

(57) ABSTRACT

Methods and systems for applying passive haptic stimulation to the muscles to stimulate afferent receptors in the muscles to treat neurological dysfunction. The muscle haptic stimulation provides modulation and retraining to treat one or more neurological dysfunctions, such as hypertonia (including spastic hypertonia), loss of motor control, and/or impaired sensation. A wearable muscle haptic stimulation system is used to apply muscle haptic stimulation for a treatment session (e.g., 3 hours daily, or 30 minutes as needed), and repeating the treatment session over a treatment period (e.g., a week, several weeks, months, etc.) in order to retrain new neurological connections thereby providing long term improvement in the neurological dysfunction.

### RELATED APPLICATION DATA

The present application is a continuation of co-pending International Application No. PCT/US2023/023122, filed May 22, 2023, which claims benefit of priority to U.S. provisional application Ser. No. 63/344,630, filed May 22, 2022, the entire disclosures of which are expressly incorporated by reference herein.

### STATEMENT REGARDING FEDERALLY SPONSORED RESEARCH AND DEVELOPMENT

This invention was made with Government support under Contract 2236014 awarded by the National Science Foundation and Contract F32 HD100104 awarded by the National Institutes of Health. The Government has certain rights in the invention.

### TECHNICAL FIELD

The present application relates to the treatment of neurological dysfunctions, and more particularly, to systems and methods utilizing passive haptic stimulation to treat neurological dysfunctions (including modulation and retraining the central nervous system), such as those caused by central nervous system injuries like stroke.

### BACKGROUND

Stroke is the leading cause of serious, long-term disability in the United States, and about half of patients suffering a stroke are left disabled, never fully recovering from the stroke. Stroke can result in loss in functionality and/or sensation in portions or throughout the half of the body opposite the affected brain hemisphere. A stroke can happen to anyone, at any time, at any age including teenagers, children, and newborns. On average, in the United States a person has a stroke about once every 40 seconds. Worldwide, the average occurrence of strokes is approximately 30 incidences of stroke every 60 seconds, with approximately 16.9 million strokes occurring in 2010 worldwide. In 2010, the estimated global cost of treatment of stroke related ailment was $863 billion, and the cost is expected to rise to $1044 billion by 2030. In addition to stroke, other neurological injuries such as traumatic brain injury, Multiple Sclerosis, and Cerebral Palsy can result in various neurological dysfunctions, including, loss of sensations and tactile perception (e.g., numbness, lack of awareness of body position and movement), loss of motor control, and/or hypertonia. As used herein, the term “spastic hypertonia” includes both chronic hypertonia from brain injury (continuous muscle contraction affecting certain muscle groups i.e. hand is curled into a fist at all waking times that may be exacerbated by excitatory drive) with or without spasticity, and spasticity (i.e., an increase in resistance to passive movement which is velocity dependent). These terms do not involve involuntary movements.

The current primary treatment for loss in functionality and/or sensation caused by neurological injury is Constraint-induced Movement Therapy (“CIMT”) and similar treatments, a specialized rehabilitation therapy wherein a patient engages in daily directed rehabilitation of an affected limb and the patient's dominant limb is restricted during daily activities. An object of the treatment is to cause the brain to grow new neural pathways as a result of the concentrated use of the affected limb to increase functionality of the affected limb.

CIMT and similar treatments of repeated exercise are highly specialized for each patient with targeted treatments to improve coordination, movement, strength, and flexibility of affected limbs based on the needs and abilities of each patient. CIMT typically requires a skilled teams of therapists and doctors for developing and administering rehabilitation programs. CIMT and similar treatments are also use-dependent (i.e., the more time spent in a therapy program, the more effective the treatment).

Although programs vary, these therapy programs typically can involve several hours of concentrated therapy per day, at least five days a week, for approximately two weeks. As part of the treatment, patients may also be required to wear restraints on their dominant limb during about 90% of their waking hours to encourage use of the affected limb while not in active therapy.

Due to the expense, time, difficulty, and need for rigorous participation on the part of both the patient and clinicians, CIMT and similar exercise-based treatments are not easily accessible or equally affective for all stroke victims. Furthermore, participation in the CIMT treatments requires a certain amount of baseline dexterity, and up to 50% of stroke survivors lack sufficient dexterity to benefit from CIMT treatments. Additionally, CIMT treatments are designed primarily to increase functionality of affected upper limbs, and CIMT is generally not a treatment for increasing functionality of the lower limbs or other parts of the body, for correcting sensory loss, for treating Unilateral Spatial Neglect (“USN”), or for reducing involuntary muscle contraction. Current therapy options targeting conditions other than upper limb functionality are few and not widely used clinically.

Electrostimulation is an alternative treatment to exercise-based therapies that involves electrical stimulation of muscles to force muscle contractions. But electrostimulation is not an ideal treatment because it is invasive, obtrusive, not mobile, and can be painful. Botox is another alternative treatment but is associated with side effects such as weakness and is temporary thereby requiring periodic treatments. Furthermore, for most patients Botox does not fully relieve symptoms even at peak effect. Baclofen oral muscle relaxant is also commonly prescribed for post-stroke spastic hypertonia, but may cause considerable side effects such as sedation.

Accordingly, there is a significant need for improved methods and devices for treating impairments caused by neurological injury.

### SUMMARY

The present disclosure is directed to innovative methods and systems for treating impairments caused by neurological injuries like stroke. The methods utilize passive haptic rehabilitation (“PHR”) which is a novel paradigm of applying mechanical stimulation, rather than exercises, to a patient's body for relief and retraining of limb dysfunction. Accordingly, the term “haptic stimulation” or similar refers to mechanical stimulation, and not electrical stimulation. PHR is referred to as being “passive” because it is applied in the background of life and does not require any active participation by the patient such as performing any movements or exercise during the therapy. PHR may even be applied in the background of other therapy or activities. The term “passive haptic rehabilitation” is sometimes also referred to generally as passive vibrotactile stimulation (VTS).

In a particularly innovative aspect, the methods and systems apply passive haptic stimulation to the muscles to stimulate proprioceptive afferent receptors (neurons that receive information from sensory organs and transmit this input to the central nervous system) in the muscles. PHR applied to the muscles is referred to herein as “MusclePHR.” MusclePHR specifically targets the afferent receptors in the muscles by configuring the frequency, amplitude, and stimulation location(s) of the vibratory PHR stimulation. The frequency is the rate of vibration of the applied vibratory stimulation. The amplitude of the stimulation is the amplitude that ultimately makes contact with the body part to which the stimulation is applied. For example, if the stimulation actuation is applied to an end effector or other part that contacts the body part, then the PHR amplitude is that of the end effector. MusclePHR differs from tactile PHR (“TactilePHR”) in that tactile PHR does not stimulate the muscle receptors because tactile PHR is cutaneous, stimulating only the skin receptors.

MusclePHR is applied to a patient's body to provide modulation and retraining to treat one or more impairments, such as hypertonia (including spastic hypertonia), loss of motor control, and/or impaired sensation. These conditions (such as paresis, hypertonia, impaired sensation) arise from areas in the central nervous system with low or no activity (and in the case of hypertonia this causes an imbalanced reliance on excitatory pathways and lack of activity in inhibitory pathways). Other conditions like tremor are distinct from these conditions in that tremor and related conditions have areas in the brain of coordinated, phasic/oscillating, or synchronized activity—not low or no activity.

Upon application, MusclePHR modulates, through excitation of weak or new tracts or inhibition of excitatory tracts, the neurological impairment to relieve symptoms of the neurological dysfunctions. In order to treat the neurological dysfunctions by retraining, which changes the central nervous activity over time resulting in new brain connections, potentiation and/or depression, MusclePHR is used to apply muscle haptic stimulation for a treatment session (e.g., 3 hours daily), and repeating the treatment session over a treatment period (e.g., a week, several weeks, months, etc.). This feature of the presently disclosed systems and methods is also understood to be novel and innovative over previously disclosed uses of PHR. Conveniently, MusclePHR may be applied in the background, at almost any time, as the therapy is passive. MusclePHR is not for maintenance, but in contrast, is a treatment method. MusclePHR in the context of spastic hypertonia cannot occur from short treatment durations that could be seen during maintenance treatment from a machine or therapist. Such mechanical stimulation treatments (i.e. massage, focal vibration) are tissue-oriented and not relearning in nature. Shorter application durations fail to instigate treatment, and only act on a tissue level like stretching exercises for maintenance do. Acceptable durations for modulatory MusclePHR in hypertonia are 20+ minutes at a time, and treatment for retraining lasts from 2 weeks or less up to months depending on the patient's needs and responsiveness to treatment. Since PHR treatment devices provide relief, they are thus designed to operate as needed, under the control of the patient and not at a prescribed schedule.

Accordingly, one example disclosed herein is directed to a muscle PHR system for applying passive haptic stimulation to muscle of a patient's body. The MusclePHR system comprises a wearable device including a wearable appliance having one or more haptic actuators disposed on the wearable appliance. The wearable device is configured to be worn on the patient's body such that the haptic actuators are positioned proximate a body part to which the muscle haptic stimulation is to be applied. The MusclePHR system also includes a controller operably coupled to the haptic actuators. The controller is configured to control the operation of the haptic actuators, including the frequency of the actuation of the haptic actuators. In another aspect, the controller may also be configured to control the amplitude of the haptic actuators. The MusclePHR system is configured to apply muscle haptic stimulation to a body part of a patient's body. In other words, the MusclePHR system is configured to apply haptic stimulation at a frequency and amplitude that stimulates the afferent receptors in the muscles of the body part to be stimulated by the haptic actuators.

In another aspect, the wearable device is configured to be worn on the hand of the patient. In still another aspect, the wearable device comprises a first strap configured to be fitted around the knuckles and the palm of a hand and a second strap configured to be fitted around the wrist and the palm of the hand adjacent to the first strap. One or more haptic actuators are disposed on the first strap in a position of the knuckles when fitted on a hand, and one or more haptic actuators are disposed on the second strap in a position of the palm when fitted on a hand. In still another aspect, one or more of the haptic actuators may be disposed on the first strap in a position of the knuckles when fitted on a hand, while one or more other haptic actuators are disposed on the second strap in a position of the palm when fitted on a hand.

In yet another aspect, the wearable appliance may be a glove. For instance, the glove may have a dorsal portion configured to fit onto the dorsal part of a hand and a plurality of finger portions each connected to the dorsal portion and configured to fit on fingers of a hand. One or more of the haptic actuators are disposed on the finger portions, and one or more of the haptic actuators are disposed on the dorsal portion. The glove can have a palm portion to which the finger portions are also connected, or it can be palm-less. In the case of a glove with a palm, one or more of the haptic actuators may be disposed on the palm portion.

In another aspect, the wearable appliance may include a grip device configured to be gripped in the patient's hand, with one or more of the haptic actuators disposed on the grip device. For instance, the grip device may be a ball (e.g., squeezable ball) or a bar that the patient can grip while muscle haptic stimulation is applied using the system.

In other aspects, the wearable appliance may be a hand orthotic brace device configured to be worn on a hand and wrist. The hand orthotic brace device may be configured to resist contractures of the hand, and also to maintain the hand in a set posture. One or more of the haptic actuators are disposed on the hand orthotic brace to apply muscle haptic stimulation to the wrist, and one or more of the haptic actuators are disposed on the hand orthotic brace to apply muscle haptic stimulation to the hand.

In another aspect, the wearable appliance may be a foot orthotic brace device configured to be worn on a foot and lower leg and which is configured to maintain the foot in a set posture. One or more of the haptic actuators may be disposed on the foot orthotic brace to apply muscle haptic stimulation to the foot, and one or more of the haptic actuators may be disposed on the foot orthotic brace to apply muscle haptic stimulation to the lower leg.

In still another aspect, the wearable appliance may be a pad device configured to be attached to another wearable device which can worn on the patient's body. One or more of the haptic actuators are disposed on the pad device. When the pad device is attached to the wearable device, and the patient wears the wearable device, the system can be used to provide passive haptic stimulation to muscle in the body area proximate the pad device.

In still another aspect of the system, the controller and haptic actuators are configured to apply muscle haptic stimulation at a frequency and amplitude that stimulates the afferent receptors in the muscles in the body area being stimulated. For instance, the controller and haptic actuators may be configured to apply muscle haptic stimulation a frequency from 40 Hz to 500 Hz, and/or at an acceleration amplitude from 1.5 g to 4 g, and/or at a deformation amplitude from 0.3 mm to 3 mm.

In addition, the haptic actuators may be configured to apply non-focal stimulation, as opposed to the focal stimulation. Furthermore, each of the one or more haptic actuators may be arranged to provide haptic stimulation in a respective non-overlapping stimulation zone. Alternatively, there may be one or more overlapping stimulation zones.

In another aspect, the controller is configured to actuate the haptic actuators according to one or more selectable and predetermined patterns. For example, the controller may actuate the haptic actuators according to a predetermined on/off pattern, or to actuate a plurality of the haptic actuators according to a respective predetermined on/off pattern (which may be different for each haptic actuator) for each of the haptic actuators in the plurality of haptic actuators.

In additional aspects, the PHR system may combine the muscle haptic stimulation with other therapy modalities. For example, the PHR system may also include one or more tactile actuators disposed on the wearable appliance. The tactile actuators are configured to apply cutaneous tactile PHR at an amplitude below the amplitude for applying muscle stimulation. The tactile actuators are also operably coupled to the controller to control the tactile actuators in applying tactile stimulation to a tactile stimulation zone. The tactile stimulation may be applied in coordination with (e.g., simultaneously, alternatingly, or a combination of both) with the muscle haptic stimulation, in overlapping stimulation zones, or in different stimulation zones (e.g., applying muscle haptic stimulation in the wrist muscles, while applying tactile simulation to the skin on the hand).

Another example disclosed herein is directed to a method of performing PHR to apply muscle haptic stimulation to treat a neurological dysfunction of a patient. The method comprises fitting a wearable passive haptic stimulation system onto a patient's body. The wearable passive haptic stimulation may be any of the PHR system disclosed herein or other, such as the example described above. The stimulation system is situated with one or more haptic actuators of the system positioned proximate a body area to apply muscle haptic stimulation. Then, muscle haptic stimulation is applied to muscle in a body area of the patient's body using the stimulation system at a frequency and an amplitude that stimulates the afferent receptors in the muscles of the body area. The muscle haptic stimulation is applied for the duration of a treatment session. For instance, a treatment session may be 20 minutes, an hour, several hours, etc. The treatment session is repeated over a treatment period to achieve retraining, including training new neurological connections providing long term improvement in the neurological dysfunction. As some examples, the treatment period may be 3 treatment sessions a week for at least a certain number of days, weeks, or months (e.g., at least 4 weeks).

Each treatment session may achieve modulation of symptoms of the neurological dysfunction, such as treating spastic hypertonia, spasms, discomfort, and/or pain, as well as improving sensation and/or motor control. In another aspect, the long-term improvement in the neurological dysfunction may include one or more of potentiation or depression of neurological function resulting in improvement of one or more symptoms of the neurological dysfunction.

In additional aspects, the muscle haptic stimulation may be applied at the frequency, acceleration amplitude and/or deformation amplitude described for the PHR system. The muscle haptic stimulation may also be non-focally and in a non-localized manner.

In another aspect, each of the one or more haptic actuators may apply haptic stimulation in a respective non-overlapping stimulation zone, or two or more haptic actuators may apply haptic stimulation in overlapping stimulation zones.

In additional aspects, the haptic stimulation may be applied according to a predetermined on/off pattern of the one or more haptic actuators. In addition, the haptic stimulation may be applied according to respective predetermined on/off patterns (which may be different for each haptic actuator) for each of the haptic actuators.

In yet another aspect, the muscle haptic stimulation is applied in coordination with (e.g., simultaneously, alternatingly, or a combination of both) one or more of cutaneous tactile PHR, electrical stimulation. In still another aspect, the muscle haptic stimulation is applied while the patient performs a therapeutic activity or exercise, which may include a robotic device, an assistive device, a neural interface, a toy, exercise equipment; and/or a support.

In still another aspect, the haptic stimulation is applied in combination with voluntary movement and/or other behavior which is tracked and used as feedback to modulate the characteristics of the haptic stimulation, such as the frequency and/or acceleration amplitude.

Other aspects and features of the present invention will become apparent from consideration of the following description taken in conjunction with the accompanying drawings.

### BRIEF DESCRIPTION OF THE DRAWINGS

The drawings illustrate examples, in which:

FIG. 1 illustrates a front perspective view of one example of a PHR device as worn on a hand.

FIG. 2 illustrates a back perspective view of the PHR device of FIG. 1 as worn on a hand.

FIGS. 3A and 3B illustrate front and back plan views of the PHR device of FIGS. 1-2 laid out flat.

FIG. 4 is a schematic view of one example of a controller of the PHR device of FIG. 1.

FIG. 5 illustrates a front view of another example of a PHR device as worn on an arm and hand, and the stimulation zones for a combination muscle haptic stimulation and tactile skin stimulation PHR treatment scheme.

FIGS. 6A-6F illustrates several examples of combined muscle haptic stimulation and tactile skin stimulation PHR treatment schemes for an upper-limb.

FIG. 7 illustrates a front perspective view of a PHR device for a lower-limb as worn on a lower leg and foot.

FIG. 8 illustrates a front perspective view of PHR device for performing a combined muscle haptic stimulation and electrical stimulation PHR treatment scheme on an upper limb as worn on an arm.

FIGS. 9A-9B illustrate front and back perspective views of one example of a glove PHR.

FIGS. 10A-10B illustrate front and back perspective views of another example of a glove PHR.

FIG. 11 illustrates another example of a PHR device having a grip device, such as a ball or a bar, which can be gripped by a hand of a patient while providing PHR.

FIGS. 12A-12C illustrate several examples of PHR devices comprising a hand orthotic brace device for maintaining a hand posture, and in coordination with muscle haptic stimulation.

FIG. 13A-13C depicts several examples of PHR devices comprising a foot pad or orthotic brace for maintaining a foot posture, and in coordination with providing muscle haptic stimulation and/or tactile skin stimulation.

FIG. 14A illustrates a plan view of a PHR pad device for a foot, and which can also be mounted on any limb-mounted apparatus, garment, robotic device, wearable device, armature, exoskeleton or the like.

FIG. 14B illustrates a plan view of a PHR pad device for a hand or any other body area, and which can also be mounted on any limb-mounted apparatus, garment, robotic device, wearable device, armature, exoskeleton or the like.

FIGS. 15A-15B illustrate an example of a PHR device for applying PHR to the fingertips, as worn on a hand.

FIG. 16 illustrates an example of a PHR system having a PHR device combined with a motion assist device.

### DETAILED DESCRIPTION

Specific examples of systems and methods for using PHR to apply passive haptic stimulation to muscles of a patient to stimulate afferent receptors to treat a neurological dysfunction will now be described with reference to the drawings. The following description of certain examples of the invention should not be used to limit the scope of the present invention. Other examples, features, aspects, examples, and advantages will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Before the examples are described, it is to be understood that the invention is not limited to particular examples described, as such may, of course, vary. It is also to be understood that the terminology used herein is for the purpose of describing particular examples only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a strap” includes a plurality of such straps and reference to “the actuator” includes reference to one or more actuators and equivalents thereof known to those skilled in the art, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Passive haptic rehabilitation (PHR) is a novel paradigm of applying mechanical stimulation, rather than exercises, to the body for relief or retraining of limb dysfunction. Instead of robotics or manual manipulation that bends or extends the limb, PHR applies haptic stimulation like vibration or tactile stimulation (which can include vibrotactile stimulation, brushing, skin stretch, etc.). PHR is not a video game or stimulation cues, which are used to provide feedback to the user, usually interactively. Instead, PHR is neuromodulatory input for relief or recovery, not information. PHR is configured to be applied in the background of life (hence “passive”), and it may be applied in the background of therapy or activities too. Even though it is passive, the subject may or may not still feel the vibrations or recognize that the device is on, active and functioning. PHR is designed to improve the limb (function or symptoms), not the limb's task performance, but improved symptoms can also improve performance. Some choose to apply and study different methods of Passive Haptic Rehabilitation, including different amplitudes, different frequencies, and different actuator activation patterns, and these are all permutations of passive haptic rehabilitation. PHR methods typically have in common: mechanical (tactile or proprioceptive) stimulation applied for relief or recovery of limb dysfunction, in the background of life, clinic time, or therapy.

“Limb dysfunction” using PHR has been studied in sensory function, tactile perception, motor control, hypertonia, stroke, and spinal cord injury. Dysfunction can also originate from other nervous system injuries or diseases. Dysfunction can involve sensorimotor control or function outside the limbs, for instance, the trunk. “Relief or recovery” here can involve central nervous system (brain, spinal cord) or peripheral nervous system change, modulation, retraining, or repair. The rehabilitation process may also affect tissue, circulation, and other changes but this is not the focus of this work—PHR is primarily for retraining or modulating the nervous system.

This unique method was defined and made capable by the creation of wearable devices that can apply such PHR stimulation unobtrusively and in a mobile form. Before this paradigm, mechanical stimulation was only applied using stationary structures and platforms in a lab. Such modes of PHR stimulation are not amiable to adherence, long durations of stimulation, or stimulation in the background of tasks.

These methods are intended for central nervous system injury such as stroke (where there is a region of the nervous system with low or no activity) and for spastic hypertonia (i.e. spasticity and hypertonia and the flexion synergy, where there is imbalanced excitatory drive to the muscles, low inhibitory drive and thus increased reliance on excitatory pathways in the brain). In addition, these methods may be applied to other similar conditions such as MS, traumatic brain injury, spinal cord injury, and the like. PHR can also be applied to conditions with different underlying mechanisms which are not the focus of this work including: cerebral palsy, spasms, training of new brain electrode arrays, prosthetics, or implants, disordered muscle tone from strain or injury, etc.

One of the most powerful features of the devices and methods of PHR disclosed herein is the premise of retraining through stimulation. No previous devices or methods use mechanical stimulation to change central nervous activity over time through retraining, resulting in new connections, potentiation, and/or depression of symptoms. Some previous technology uses electrical stimulation, brain stimulation, such as transcranial magnetic stimulation (TMS) or spinal stimulation (electrical). The PHR disclosed herein does not utilize electrical stimulation alone, nor is it active stochastic input to change perception or dexterity. Rather, the PHR technology disclosed herein is a paradigm of retraining (i.e. perception or dexterity) over time in part or in full by mechanical stimulation. The PHR disclosed herein is also differentiated from pneumatic input and compression at a hospital, which may encourage limb circulation or change acute injury healing; thus, PHR applied before or after the acute phase is usually during daily life, and is a retraining or modulating paradigm. As described herein, the use of a wearable device uniquely enables long durations of stimulation, or stimulation at convenient times, which boosts the likelihood of adherence to this method. In addition, since PHR is based on stimulation and not exercises, it is accessible to patients with low or high function. PHR retraining may be applied during a treatment period, i.e. a week, two months, and may be applied for extended periods of time per day or at a time (i.e. 3 hours daily), or could be applied for short periods (i.e. 30 minutes as needed). As discussed herein, PHR retraining and PHR modulation can also be applied during a preferred activity (e.g., during therapy or during rest—when the patient does not need to use their body, or during walking—when symptoms might bother patients). PHR is intended to be applied in the background of any time, even during sleep. The methodology to enable this method has not previously been articulated. Now, only after three clinical trials are we able to define the method underlying this paradigm. It is as follows: Using an apparatus to apply haptic (specifically proprioceptive, tactile, vibratory, or vibrotactile) stimulation for rehabilitation, changing or improving or retraining nervous system connections, and repeating these stimuli for a retraining period.

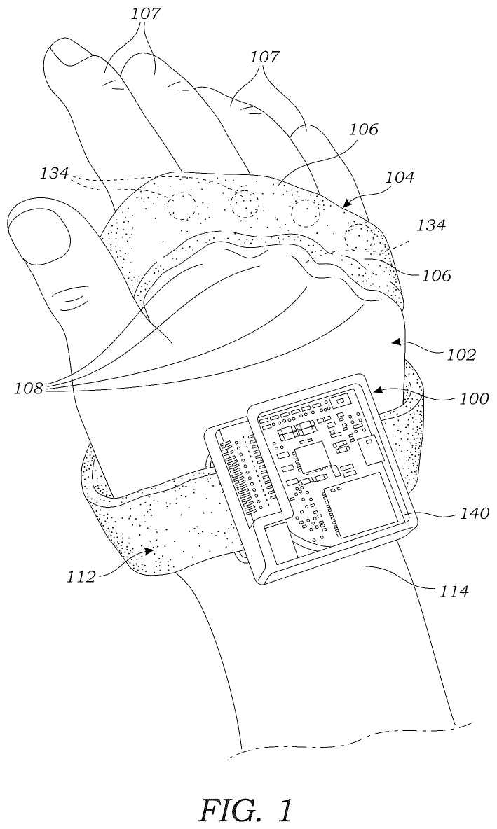

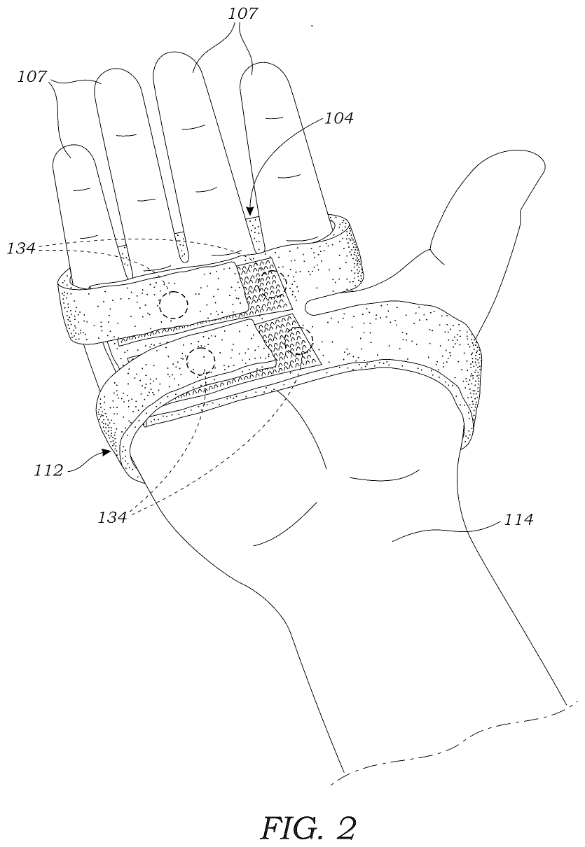

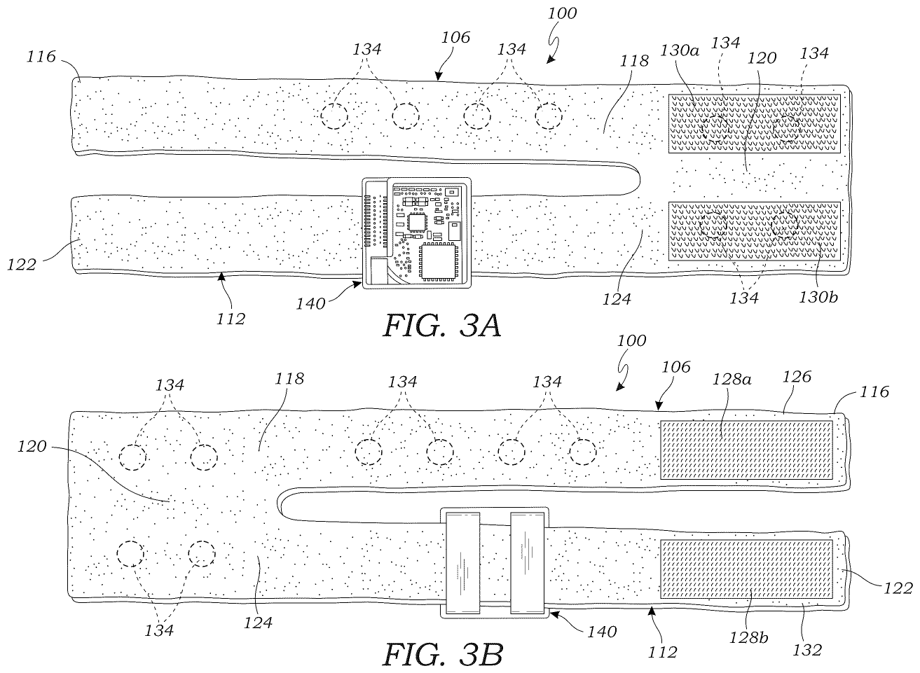

Referring now to FIGS. 1-3, one example of a passive haptic rehabilitation (PHR) device 100 configured to perform PHR on a subject's hand 102 is illustrated. The PHR device 100 comprises a wearable appliance 104 which is configured to be worn on the subject's hand 102. The wearable application 104 is made of a fabric material or other comfortable material to be worn on the subject's body, such as subject's hand 102. In the example shown in FIGS. 1-4, the wearable application 104 is made from two layers of fabric material, a top layer 105a and a bottom layer 105b sewn together around the edges to form a compartment between the two layers 105a, 105b into which the components of the PHR device 100 are housed. The wearable appliance 104 includes a first strap 106 configured to be fitted around the knuckles 108 and the palm 110 of the hand 102 and a second strap 112 configured to be fitted around the wrist 114 and the palm 110 of the hand 102 adjacent to the first strap 102. The first strap 106 has a loose first end 116 and a second end 118 connected to a palm portion 120 of the wearable appliance 104. The second strap 112 has a loose first end 122 and a second end 124 connected to the palm portion 120.

An attachment portion 126 proximate the loose first end 116 of the first strap 106 detachably fastens to the wearable appliance 104 by a fastener 128a to allow the first strap 106 to be fitted around fingers 107 just distal of the proximal (large) knuckles 108 and secured onto the hand 102. The fastener 128a fastens the attachment portion 126 to a mating fastener 130a on the palm portion 120 or another portion of the first strap 106. For example, the fastener 128a and mating fastener 130a may be mating hook and loop fasteners, snaps, or other suitable fastening devices. Similarly, an attachment portion 132 of the second strap 112 detachably fastens to the wearable appliance 104 by a fastener 128b for fastening the second strap 112 onto the wrist 114. The attachment portion 132 fastens the attachment portion 132 to a mating fastener 130b on the palm portion 120 or another portion of the second strap 112. Alternatively, or in addition, the second strap 112 may have a buckle 131 for securing the second strap 112 onto the wrist 114.

As illustrated in FIGS. 1-2, haptic actuators 134 are disposed on the first strap 106 in the compartment between the two layers 105a, 105b, in a position of the dorsal side of each finger 107 just distal of the respective proximal knuckles 108 when fitted on the hand 102, such that the haptic actuators 134 provide haptic stimulation to each finger 107 when actuated. Haptic actuators 134 are also disposed between the two layers 105a, 105b on the palm portion 120, such as on the palm in a position at the base of each finger and another haptic actuator 134 positioned on the palm toward the middle of the palm, when fitted on the hand 102. The haptic actuators 134 may be any suitable vibratory device, such as vibration motors, coin vibration motors, eccentric vibration motors, linear reciprocating motors, piezoelectric vibration devices, etc. The haptic actuators 134 in different locations of the PHR device 100 may be the same or different haptic actuators. For example, the haptic actuators 134 on the first strap 106 and positioned on the dorsal side of the fingers 107 may be different than the haptic actuators 134 on the second strap 112 and positioned on the palm.

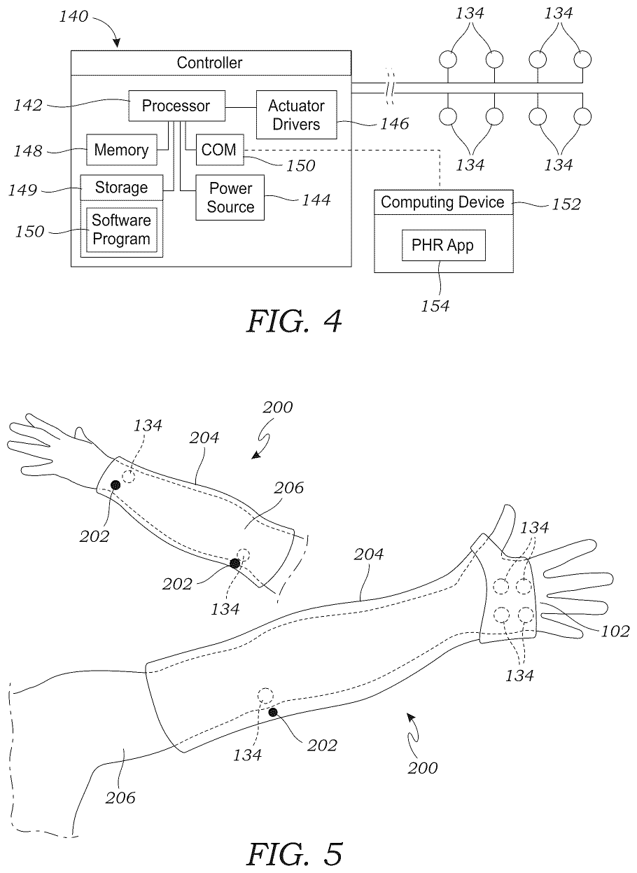

The PHR device 100 also includes a controller 140 attached to the second strap 112. The controller 140 is operably coupled to each of the haptic actuators 134 and is configured to actuate and control the haptic actuators 134. As shown in the block diagram of FIG. 4, the controller 140 may be an electronic controller having a processor 142, a power source 144 (e.g., a battery), memory (e.g., non-volatile and/or volatile memory) 148, a storage device 149 (non-volatile storage) and one or more drivers 146 for actuating the haptic actuators 134. The controller 140 may also include a communication module 150 configured to communicate via a communication protocol to a computing device 152. The communication module 150 may be any suitable communication module for communicating with the computing device 152, such as a Bluetooth communication module, Wi-Fi communication module, cellular communication module, or the like. The controller 140 may be programmable via a controller software program 150 stored on the storage device 149. The controller software program 150 includes instructions for operating the PHR device 100, including controlling the actuators 134, as well as interfacing with the PHR software app 154 on a computing device 152 (e.g., a smartphone, a tablet computer, a personal computer, or the like). The controller 140 may be configured to individually control each of the haptic actuators 134 such that each haptic actuator 134 is actuated at its own individual actuation mode, or it may control the haptic actuators collectively such that each haptic actuator 134 is actuated in unison with the others. A PHR software application 154 may be installed on the computing device 152. The PHR software application 154 is configured to allow a user to adjust the settings of the PHR device 100, such as the characteristics of the haptic stimulation (e.g., frequency, amplitude, therapy cycle and schedule, etc.), and also track the therapy sessions and relief and modulation of symptoms achieved by the therapy.

While having the controller 140 attached to the second strap 112 as shown in the example of FIGS. 1-4 provides a convenient and portable PHR device 100, the controller 140 may alternatively be separate from the wearable appliance 106, such as being housed in a separate module which is operably coupled to the haptic actuators 134. The controller 140 may be operably coupled to the haptic actuators 134 via wired connections, or via wireless communications such as Bluetooth, Wi-Fi, or the like. In the wireless example, the controller 140 and haptic actuators 134 are provided with respective communication modules for enabling the particular mode of wireless communication.

The operation and use of the PHR device 100 to perform vibrotactile stimulation (PHR) will now be described. In the example of FIGS. 1-4, the PHR device is configured to perform PHR on a subject's hand to treat symptoms of neurological disorders caused by, for example, stroke or other brain injury. The symptoms may include one or more of hypertonia (including with or without spasticity), loss of sensory and/or motor function, and/or spatial neglect. PHR is performed by the haptic actuators 134 on PHR device 100 at particular characteristics to activate the tactile and/or proprioceptive receptors in a treatment region. The characteristics of PHR include the location, frequency, amplitude, and pattern of the PHR treatment. The frequency, amplitude and pattern of PHR applied by the haptic actuators 134 may be controlled by the controller 140, which controls the frequency and/or pattern of operation of the haptic actuators 134. The controller 140 may be programmable to program a treatment program, including the frequency and pattern of the operation of the haptic actuators 134.

The PHR treatment is defined most by the placement of the haptic actuators 134. Accordingly, the PHR device 100 is a wearable device which positions the haptic actuators 134 at target body area(s) to apply PHR where it will activate the tactile and/or proprioceptive receptors in a treatment region to relieve and modulate the symptoms, as well as retrain central nervous system activity over time through a PHR regimen, resulting in new connections, potentiation, and/or depression of symptoms. As described herein, other wearable devices or stationary devices can be used, and wearable devices include gloves, wraps, bands, bracelets, arm bands, balls, braces, passive exoskeletons, active exoskeletons, orthotics, manipulanda (e.g., a joystick where the vibration actuators are in the joystick being grasped such that the vibrations are applied to the palm), pads that attach to the limb, etc., which are configured to apply PHR at various treatment regions of the body. The wearable devices or stationary devices may have a single haptic actuator or multiple haptic actuators to apply PHR. In addition, the haptic actuators may be applied to reach multiple different zones, or they may be adjacent to different zones to provide a variable stimulation pattern for patient comfort, or to cover a larger area of skin (e.g. for TactilePHR as described herein). Moreover, the haptic actuators may cover independent receptive fields or overlapping receptive fields.

In the particular case of the hand PHR device 100, as shown in FIGS. 1A and 1B, the PHR device 100 is worn on the subject's hand 102 such that the vibratory haptic actuators 134 are positioned on the dorsal side of the fingers 107 near the intrinsic hand muscles and lumbricals just distal of the respective proximal knuckles 108 when fitted on the hand 102, and on the palm of the hand 102. FIGS. 1-3 show a PHR device 100 for use on a right hand of a subject. A PHR device 100 may also be configured for use on a left hand of a subject. In addition, more than one PHR device 100 may be used at the same time, such as a PHR device 100 for each hand 102. The multiple PHR devices 100 may have their own individual controllers 140, which may or may not communicate with each other via a wired or wireless communication mode, or the multiple PHR devices 100 may utilize a single controller 140 configured to connect to and control multiple PHR devices 100.

The PHR device 100 is configured to apply the PHR stimulation using the haptic actuators 134 vibrating at a frequency that activates the tactile and/or proprioceptive receptors (i.e., PHR stimulation, also called PHR stimulation. The frequency of the haptic actuators that applies PHR stimulation is in the range between 0-500 Hz. During a treatment session, the frequency of PHR stimulation can automatically vary or be intentionally changed by the user during stimulation or changed according to the receptor targets or changed depending on the user's movement or behavior. For example, the frequency of PHR stimulation can be changed between a range or discrete set of frequency settings, automatically or manually, which is beneficial especially for somatosensory retraining. The frequency can also be unchanging, excluding natural ramp-up that occurs as the haptic actuators 138 (e.g., as vibration motors start up and gain speed). A variety of receptive units in the skin can be activated by haptic actuators 138, such as eccentric vibration motors, and thus are preferable for skin stimulation. Stimulation can be designed to repeat at a certain setting and then progress to repeating a different setting.

The amplitude of PHR stimulation also affects the receptors being stimulated, and the overall effectiveness of the PHR treatment. The amplitude of PHR stimulation is measured by the amount of deformation and force of the PHR stimulation, and the amount of force is a function of the acceleration amplitude of the haptic actuators 138. The amplitude of PHR stimulation applied by the haptic actuators 138 for effective PHR stimulation ranges from 0.1 g to 4 g or more acceleration amplitude and a deformation in the range of 0.1 mm to 4 mm, or more. Still, PHR stimulation may also include near-zero amplitudes of acceleration and deformation, such that the PHR stimulation consists of primarily vibration. PHR stimulation from vibration will travel throughout neighboring tissues, thereby stimulating a larger area of the treatment region.

The pattern of operation of the haptic actuators 134 also affects the PHR stimulation. For example, the pattern of the actuation of the haptic actuators 134 may or may not include pauses between stimuli, and may or may not include overlapping stimuli. The PHR stimulation patterns prioritize sensory activation and prevent habituation and adaptation. A number of novel actuation patterns as described below:

For a single haptic actuator 134 per target treatment zone, the actuator pattern may include any one or more of the following:
1. On continuously
2. On and off with unchanging times: even on/off time, greater on time than off time, or greater off time than on time
3. On and off with variable on times, which may be preprogrammed or random.

For multiple haptic actuators 134 per target treatment zone, the actuator pattern may include any one or more of the following:
1. Song: A novel stimuli pattern where actuators can be activated multiple times with no requirement for the other actuators to be activated before reactivating the same actuator. I.e., an actuator 1 can be activated multiple times in a row, without actuators 2-n being activated. Or, actuator 1 can be activated multiple times, with some but not all actuators being activated.
   a. Activation times are ideally variable: either repeating at a given activation duration before changing the duration or varying the activation duration based on a program or randomly. Pauses can be for 0-300 seconds between stimuli and can also vary.
   b. Actuator times can also be unchanging.
2. Balanced song: A novel stimulation pattern that is the same as 1. above but is balanced for the activation of actuators so all zones or all actuators are activated the same number of times in total.
3. One or more (up to all) actuators with overlapping or simultaneous activation.

Especially for spasticity and spastic hypertonia, PHR treatment can relieve and modulate symptoms. Relief begins after about 20-30 minutes of PHR stimulation, and the effects can last hours to days to weeks. Shorter application durations fail to instigate treatment, and only act on a tissue level like stretching exercises for maintenance do. Modulation may be applied occasionally or regularly (i.e. daily or 3 days per week), as needed when symptoms are high, daily at a preferred time, preventatively before expected symptoms, or throughout the day.

The PHR device 100 may be used according to a regimen of individual PHR treatment sessions applied over a period of time, such as days, weeks, months, or years, to achieve retraining effects which can provide long term relief. Such retraining effects may be due to long term potentiation or long-term depression of brain regions, and/or to new or strengthened connections. The exact mechanism is still being investigated. For example, a regimen may comprise a number of PHR treatment sessions per week (e.g., 2, 3, 4 or more sessions per week) over a period of a number of weeks (e.g., in the range of 3-20 weeks) or a number of months (e.g., in the range of 2-12 months) or longer.

The characteristics of the PHR applied by the haptic actuators 134 may also be set to specifically perform certain types of stimulation, such as MusclePHR, TactilePHR, and/or a combination of TactilePHR and MusclePHR (referred to as SMPHR). As described herein, MusclePHR can retrain or modulate hypertonia (including spasticity), sensory and motor function, and spatial neglect. Proprioceptive “muscle” stimulation is defined by its target of afferent receptors in the muscles (such as the muscle spindles) or the tendons (such as Golgi tendon organs (GTOs)). MusclePHR specifically targets these receptors by operating the haptic actuators 134 at a specific selection of frequency, amplitude, and stimulation locations. For MusclePHR, the haptic actuators 134 apply PHR near a frequency of 70 Hz, or within a range of 40-100 Hz. For MusclePHR, the haptic actuators 134 apply PHR at higher amplitudes than TactilePHR, namely in the range of 0.1 g-4 g acceleration amplitude and deformation of 0.3 mm-3 mm. This amplitude is the amplitude that ultimately makes contact with the target body area. For instance, each of the haptic actuators 134 may include a respective end effector operably coupled to, and driven by, the actuators 134, such that the end effectors contact the body and applies the PHR. If the actuation is applied to an end effector or other part that makes contact with the target body area, then the PHR amplitude is that of the end effector. The MusclePHR applied by the PHR device 100 can cause indentation of the skin by an actuator, a probe, or an end effector can occur. MusclePHR is applied to the zones described in the list below, which are discrete from the zones of TactilePHR described below. MusclePHR is applied using the vibratory haptic actuators 134, or may be applied using other stretching or deformation actuators. Tactile actuators like air (e.g., light-pressure air), brushing, etc. will not work to provide MusclePHR and thus are one of the key enabling and differentiating features of the examples described herein.

Although noninvasive stimulation must always be applied to the skin in order to reach the muscles and tendons, engineering choices (i.e. the discrete application location/zones described below) make this cutaneous (skin) input negligible. The paradigm of combined or simultaneous Skin (also referred to as “tactile”)+Muscle stimulation is described below. Here are some enabling features and variations of the PHR device 100:
1. Stimulation need not be targeted to a muscle group or muscle. MusclePHR stimulation can be non-focal and localized/targeted.
   a. Contrary to the paradigm of muscle stimulation using other approaches, PHR can be applied non-focally to tendons and muscular regions including spastic and paretic muscles, both antagonists and agonists.
   b. Non-focal stimulation design need not be custom to the patient symptoms.
   c. Focal stimulation (targeted to a specific muscle) can also be used, but does not increase efficacy.
2. Target zones in the upper limb: forearm muscle belly, upper arm muscle belly, intrinsic hand muscles, pectoral muscles.
3. Target zones in the lower limb: intrinsic foot muscles, muscle belly below the knee (tibialis anterior, gastrocnemius, soleus), muscle belly of the thigh (although spastic hypertonia here can sometimes be beneficial and thus may not be a clinical aim to reduce it)
4. Apply stimulation over the target zone
5. Apply stimulation on the bones underlying the target zone**
6. Apply stimulation to the tendons near the target zone
7. Not for maintenance
8. For retraining:
   a. to apply proprioceptive stimulation for rehabilitation, changing or improving or retraining nervous system connections, repeat these stimuli for a retraining period.
9. For modulation:
   a. to apply proprioceptive stimulation for rehabilitation, changing or improving or retraining nervous system connections, for a treatment period with immediate, near immediate, or results after less than 60 minutes.

Tactile and proprioceptive (skin, muscle, and/or tendon) stimulation can also be applied in combination (e.g., simultaneously, alternatingly, or a combination of both) for PHR. FIG. 5 illustrates an example of a PHR device 200 for applying combined muscle haptic stimulation and tactile (also called “skin”) haptic stimulation (Tactile PHR). The PHR device 200 may include the same features and is configured to operate similar to the PHR device 100. For instance, the PHR device 200 may include a wearable appliance 204, of similar construction to the wearable appliance 104, except shaped to fit on the arm 206 and hand 102 of the subject. As depicted in FIG. 4, a PHR device 200 includes haptic actuators 134 disposed on the wearable appliance 204 and positioned to apply PHR to the bone regions 202, which are also a target for PHR to provide either targeted stimulation or non-focal stimulation. The PHR device 200 also includes haptic actuators 134 disposed on the wearable appliance 204 and positioned on the hand 102, which are configured to apply MusclePHR to the regions of the hand 102, and a controller 140 (not shown) operably coupled to the haptic actuators 134, same or similar to the PHR device 100. Accordingly, the PHR device 200 is configured to apply TactilePHR and/or MusclePHR to the bone regions using the haptic actuators 134 positioned in the bone regions 202, and TactilePHR and/or MusclePHR to the hand zones 102, as shown in FIG. 5. The PHR device 200 can apply PHR stimulation to bones to provide strong PHR input, e.g., at the elbow bone protrusions to reach forearm muscles, and to the hand zones, as shown in FIG. 5.

In contrast to simply applying noninvasive muscle stimulation (MusclePHR), which will also make contact with the skin but ultimately negligible cutaneous activation, Skin+Muscle PHR (SMPHR) is tuned to both the skin and muscles. This tuning to achieve SMPHR is accomplished by selection of the following characteristics of the PHR being applied:
1) frequency and amplitude of the operation of the haptic actuators 134,
2) stimulus location, and

3) properties of the haptic actuators 134. TactilePHR is applied at a frequency of about 250 Hz or at a frequency ranging between 1-500 Hz. Amplitude choices for tactile stimulation determine the activated region of sensory receptors. Larger regions of skin activation improve the magnitude of sensory input. Very low amplitude stimulation can be applied for localized tactile stimulation below the perceptual threshold. TactilePHR can be applied by stimulation at the fingertips, fingers, palm, wrist, hand, plantar foot, or toes. If a region different from these is chosen, TactilePHR may not occur unless a larger zone of stimulation input (i.e. more actuators over more skin area), or >1.5 g acceleration amplitude is used. TactilePHR may use any of a variety of tactile actuators (which may not require an operating frequency) including: vibrotactile, piezoelectric, brush, skin stretch, light touch, etc. These are the requirements for TactilePHR. Although certain examples of the devices and methods disclosed herein are described for MusclePHR and/or skin+MusclePHR, they may also be configured for skin only PHR by configuring the haptic actuators and controller to apply haptic stimulation of just the skin.

The application of MusclePHR by the PHR device 200 is the same as described above.

The various methods of using the Skin+Muscle devices, such as the PHR device 200, to apply PHR may include the following features and variations:
1. alternate skin and muscle stimulation with equal time, or with more of one type of stimulation than the other
   a. optional pauses between stimuli
   b. equal or unequal time spent on each actuator
2. simultaneous skin and muscle stimulation
3. a mixture of alternate and simultaneous SMPHR
4. all of the above stimulation approaches should be applied in the method of PHR: using an apparatus to apply stimulation, for rehabilitation, changing, improving, or retraining nervous system connections especially for spastic hypertonia and impaired sensorimotor function after stroke, applying this stimulation repeatedly for a treatment or retraining period.

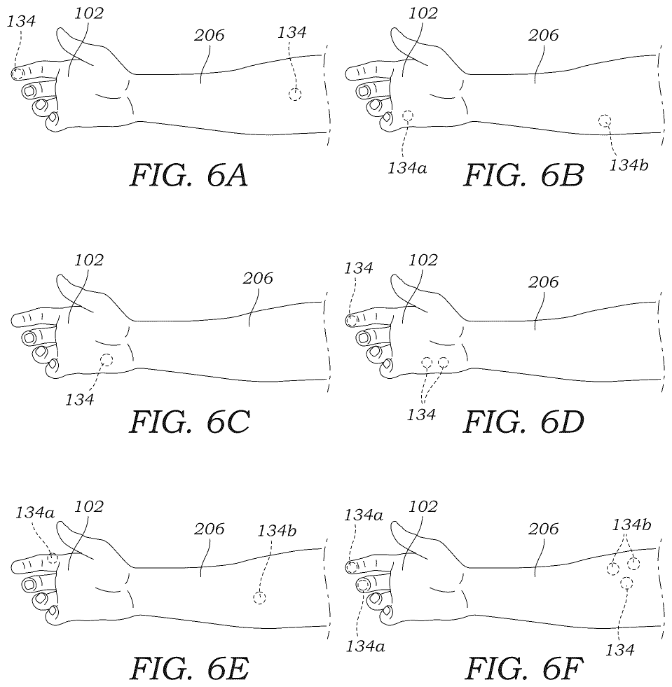

FIGS. 6A-6F shows several variations of combined MusclePHR and TactilePHR examples having various locations and numbers of haptic actuators 134 for PHR treatments of an upper limb. FIGS. 6A-6F also show various methods of alternation of applying PHR by the different haptic actuators 134, described as follows:
1. Alternates between sites (locations, actuators 134) (see FIG. 6A)
2. Alternates between sites (locations, actuators 134) and frequencies and/or amplitudes characteristics (see FIG. 6B). For example, haptic actuator 134a may operate at a frequency of 240 Hz, and an acceleration amplitude of 0.5 g, and Haptic actuator 134a may operate at a frequency of 70 Hz, and an acceleration amplitude of 2.0 g. Or range of frequencies, including a changing frequency within the MusclePHR or TactilePHR ranges.
3. Alternating skin stimulation and muscle stimulation at different frequencies and/or amplitudes (see FIG. 6C). For example, haptic actuator 134 may operate at a low amplitude (<2 g), and TactilePHR alternates with high amplitude MusclePHR at a frequency 20-100 Hz.
4. Simultaneous skin stimulation and muscle stimulation at different frequencies and/or amplitudes (see FIG. 6D). For example, haptic actuator 134 may operate at a frequency of 60 Hz, and an acceleration amplitude of 2.0 g, simultaneously with TactilePHR.
5. Simultaneous different sites (locations, actuators) (see FIG. 6E). For example, haptic actuators 134a and 134b may operate simultaneously at a frequency of 175 Hz.
6. Simultaneous different sites (locations, actuators 134) and frequencies and/or amplitudes characteristics (see FIG. 6F). For example, haptic actuators 134a may operate at frequency of 240 Hz and an acceleration amplitude of 0.5 g simultaneously with haptic actuators 134b operating at a frequency of 70 Hz and an acceleration amplitude of 2.0 g.

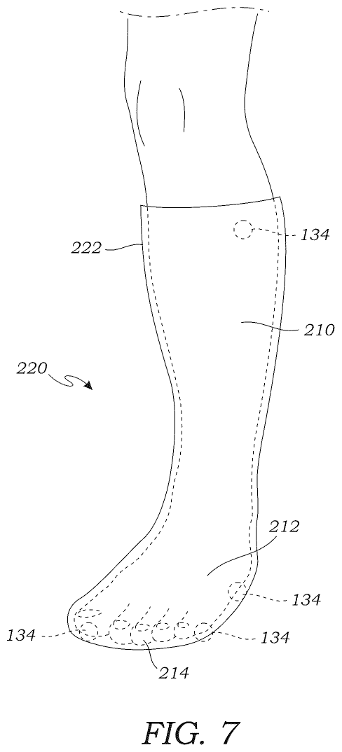

FIG. 7 shows another example of a PHR device 220 for applying combined MusclePHR and TactilePHR to a lower limb, such as the lower leg 210, foot 212 and toes 214. The PHR device 220 includes a wearable appliance 222 which fits on the foot and lower leg of a subject. One or more haptic actuators 134 are disposed on the wearable appliance 204 and positioned to apply MusclePHR and/or TactilePHR to the regions of the foot 212, lower leg 210 and/or toes 214. The PHR device 220 also includes a controller 140 (not shown) operably coupled to the haptic actuators 134, same or similar to the PHR device 100.

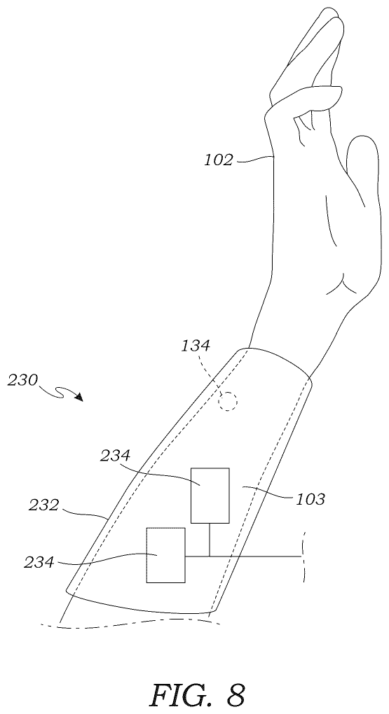

PHR can also be effectively applied with a combination of electrical and mechanical stimulation. PHR is not electrical stimulation, but the haptic stimulation of PHR can be combined with electrical stimulation (ranging in strength and purpose from functional to afferent). FIG. 8 illustrates an example of PHR device 230 configured to apply combined electrical stimulation PHR and MusclePHR (EMPHR) treatment scheme for an upper limb, such as the forearm 103 and/or hand 102. The PHR device 230 includes a wearable appliance 232, such as a sleeve or other wearable structure, and one or more haptic actuators 134 disposed on the wearable appliance 232 and positioned to apply MusclePHR to the regions of the haptic actuators 134. The PHR device 230 also includes one or more electrical stimulation electrodes 234 disposed on the wearable appliance 232 and positioned to apply electrical stimulation PHR to the regions of the electrodes 234.

Various methods of using a combined MusclePHR and electrical stimulation PHR device, such as the PHR device 230, to apply PHR may include the following features and variations:
1. when electrical stimulation is afferent in nature (transcutaneous electrical nerve stimulation (TENS), afferent e-stimulation, etc.):
   a. alternate mechanical and electrical stimulation with equal time, or with more of one type of stimulation than the other
   b. simultaneous mechanical and electrical stimulation
   c. a mixture of alternate and simultaneous EMPHR
2. when electrical stimulation is functional in nature—aiming to achieve a task or provide movement or assistance:
   a. provide PHR stimulation during functional assistance to modulate or retrain spastic hypertonia or sensorimotor function.
   b. provide PHR stimulation asynchronously with functional assistance to modulate spastic hypertonia
   c. provide PHR stimulation asynchronously from the same electrical stimulation device when not using electrical stimulation functions, to provide retraining.

In still another example disclosed herein, PHR stimulation can also co-occur with activities. In fact, PHR is effective at modulating spastic hypertonia which may be aggravated during activities such as walking, exercises, or therapy. The PHR devices disclosed herein can be designed to complement these activities or automatically onset when an activity is started, planned, or when symptoms are sensed. For example, the controller 140 may include sensors and/or programming to determine that a subject is performing a certain activity, and then operate the PHR device to apply PHR stimulation. Task performance can include other equipment such as robotics, assistive devices, neural interfaces, toys, exercise equipment, or supports, or vocational or recreational activities. Various methods of applying PHR simulation to co-occur with specific tasks using the PHR devices and methods disclosed herein may include the following features and variations:
1. apply PHR stimulation during therapy or exercise to modulate symptoms, thus improving efficacy and ease of the activity.
2. apply PHR stimulation (passive haptic stimulation) during therapy or exercise to provide simultaneous retraining from PHR, amplifying the effect of therapy and exercises.
3. automatically start or stop PHR when an activity is started, planned, or when symptoms are sensed.
4. automatically or manually start and stop PHR by time of day or according to medication schedule.

PHR devices and methods may also be configured to sense and respond to specific activities. For instance, task-centered PHR stimulation treatment and training can be translated to real life tasks which are more entertaining than general exercises. PHR can be designed to sense and respond to activities. For example, a subject may be tasked with moving into a box. A PHR device as disclosed herein, such as the PHR device 100, senses when a block is picked up and provides modulating PHR stimulation during reaching and release. Such PHR stimulation may be referred to as SmartTaskPHR. This is not a video game or interactive task involving haptic cues (such as a glove that pulses to indicate what finger to stimulate). Instead, this is PHR stimulation designed for therapeutic benefit, not conveying instruction or cues. PHR stimulation does not need to be attended to or focused on, it is “passive” and occurs in the background. SmartTaskPHR is designed not to sense the person, but instead to sense the task.

Various method of using SmartTaskPHR may include the following features and variations:
1. A closed loop stimulation system or method during therapy at home or in a clinic.
   a. Stimulation may be tactile or proprioceptive or both.
   AND
   b. Sensors may be embedded or attached in the task, or stimulation can be preprogrammed to correspond to the task
      i. Stimulation or sensing could be from a specialized device OR commercial device such as smartwatch or smart bracelet
   c. A device may come with both stimulators and task equipment
   d. A PHR device may be designed to work with standard tasks or assessments
   e. A PHR device may automatically determine the stimulation that could correspond to the task or variety of types of tasks

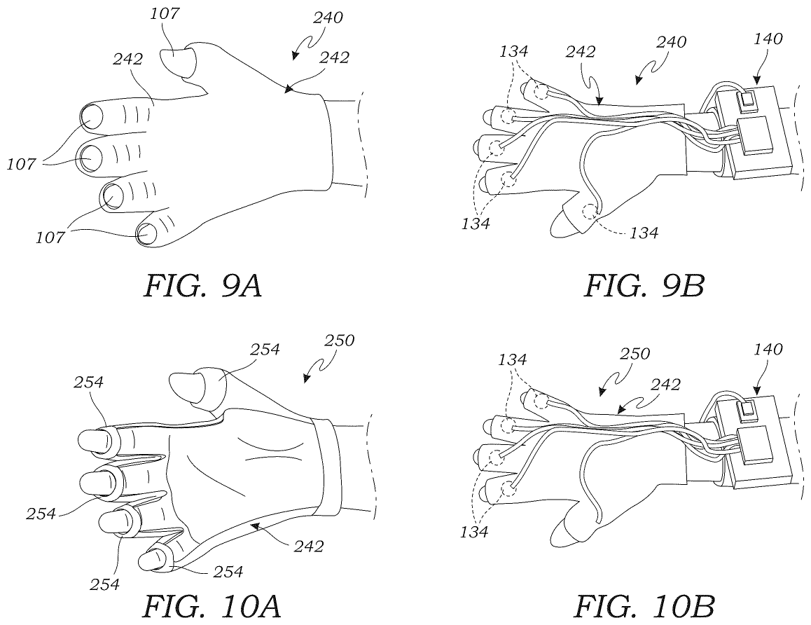

Turning now to FIGS. 9-10, a couple of examples of PHR devices incorporated into gloves to be worn on a subject's hand for performing PHR on a hand 102 are illustrated. These glove examples of PHR devices are similar to the PHR device 100 and may include any one or more of the features and aspects of the PHR device 100 as described herein. The PHR device 240 shown in FIGS. 9A-9B comprises a glove 242 as the wearable appliance. The glove 242 has open ends to the fingers, but alternatively, may have fully fingers with a closed end. The glove 242 also has a full palm portion which covers the palm of the hand 102. The PHR device 240 has a plurality of haptic actuators 134 disposed on the glove 242 and positioned on the dorsal side of each finger 107. The haptic actuators 134 are shown positioned distal of the large knuckle in the example of FIG. 9A, but may be positioned on each finger at the fingertip, any phalanx segment, and/or on any knuckle. The controller 140 of the PHR device 240 is configured to be worn on the wrist using a wrist strap. Alternatively, the controller may be configured to be secured to the neck, body, a lanyard, or on the glove 242. The PHR device 240 may also have haptic actuators 134 (not shown) disposed on the glove 242 and positioned on the palm, same or similar to the haptic actuators 134 in the palm area of the PHR device 100.

The PHR device 250 shown in FIGS. 10A-10B is similar to the PHR device 240, except that the PHR device 250 is palm less (the palm is uncovered by the glove 242) and has a separate fastening mechanism 254 for fastening each haptic actuator 134 to a respective finger 107 or other part of the hand 102. The fastening mechanisms 254 may comprise straps and hook and loop fasteners, or other suitable closures, such as magnets, hooks, clips, etc.

Other designs for a wearable PHR device were developed, and through experimentation, it was found that a device for PHR of the hand in conditions such as stroke and hypertonia needs specific features. In some cases, certain features were found to underperform, and such information helped form the basis for design of the other PHR devices disclosed herein.

Individual sleeves or fixtures for the fingers were designed by the investigators but are preferably replaced. One novel solution involves one or two fixtures (i.e. straps) for the fingers, but individual indentations or arches for each finger. This allows each finger to be individually stimulated or sensed, and this can fit on hands that are limp (paresis) or contracted (spasticity, hypertonia, or contractures). These arches or indentations can rest anywhere along the fingers. Alternatively, the PHRglove should have a single strap over the fingers resting near the MCP joint, or two straps for the fingers (one near the MCP joint and one near the PIP joint). Fixtures that attach PHR devices at the volar hand (palm of the hand) or the anterior arm are not usable by a population with impaired limb function as was found through study that supination of the arm is one of the first motions to become impaired. Accordingly, it is preferable to design PHR devices that can be attached using cinch buckles, or fixtures that attach at the dorsal upper limb.

Fixtures or material between the fingers require abduction of the fingers and are best replaced in users with impaired limb function. In addition, it is desirable to have minimal fabric coverage area of the skin using features like an open palm, fingerless design, open back, etc. This provides for a more comfortable and breathable device.

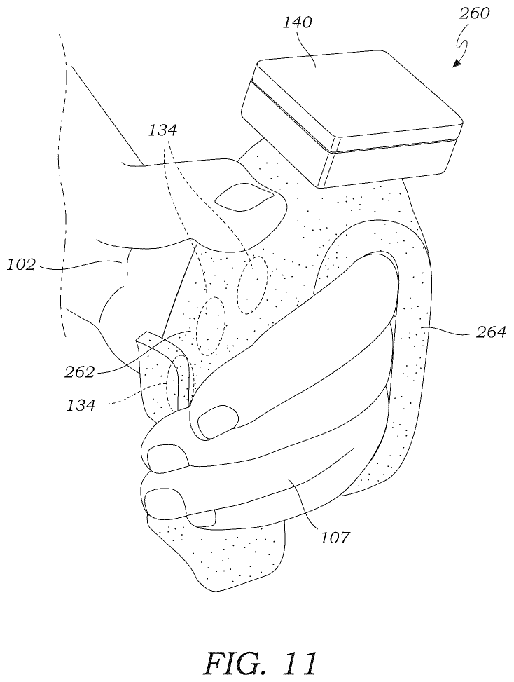

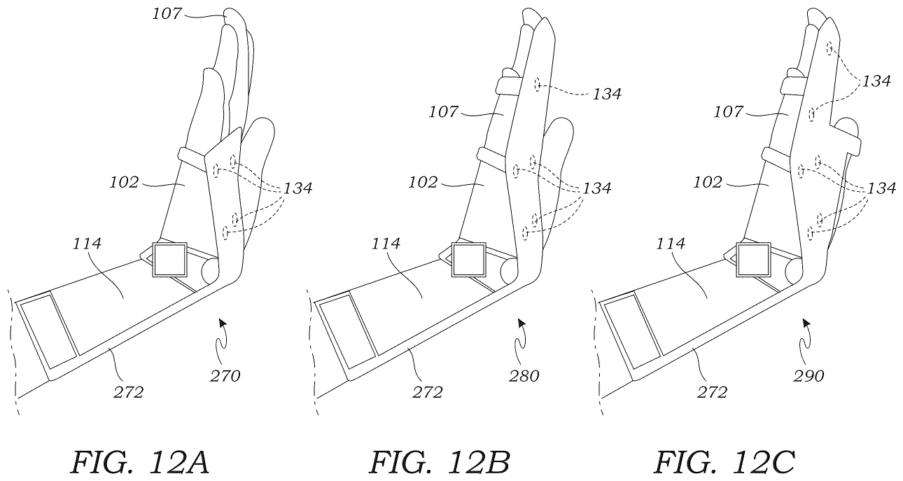

Referring now to FIG. 11, another example of a PHR device 260 for performing PHR on the hand is illustrated. The PHR device 260 is designed to allow the subject to squeeze the device during use (such methods and devices are also referred to as “PHRsqueeze”). Patients with hypertonia for example may like to grip something like a pad or rod in their hand 102 while performing the PHR treatment. The PHR device 260 includes a squeeze element 262, such as a ball or a bar, configured to be held in the palm of the hand 107. The squeeze element 262 may be pliable like a squeeze toy or relatively stiff. One or more haptic actuators 134 are disposed on squeeze element 262 and are positioned to apply PHR to the palm of the hand 107. The PHR device 260 may also include a strap 264, or other attachment element, to fasten the PHR device 260 to the hand 102. The PHR device 260 also includes a controller 140 which may be attached to the squeeze element 262 or strap 264, or it may be contained within the squeeze element. The PHR features described herein may also be combined with braces for maintaining body parts in a specific posture, such as counteracting contractures caused by neurological dysfunction (such methods and devices also referred to as “PHRcounteract”). PHRcounteract prevents contractures from developing and keeps the treated body part (e.g., a hand) in a preferred posture, and also improves the experience of preventing contractures by simultaneously providing PHR—passive training to relieve hypertonia and spasticity. This also reduces the difficulty in keeping the body parts from bending (e.g., the fingers and wrist from bending), and also can retrain spastic hypertonia. FIGS. 12A-12C illustrate several examples of PHR devices 270, 280, 290, for use in treating a hand 102 and wrist 114 of a subject. The PHR devices 270, 280, 290 comprise a hand orthotic brace device 272 for maintaining a hand, wrist and/or finger posture, and a plurality of haptic actuators 134 disposed on the volar facing side of the hand orthotic brace 272. The PHR devices 270, 280, 290 also have a controller 140 (not shown) operably coupled to the haptic actuators 134, same or similar to the PHR device 100. The PHR devices 270, 280, 290 may also include a fabric cover or other material covering the haptic actuators 134 such that the cover is between the actuators 134 and the skin of the subject during use. In addition, the actuators 134 may be embedded or otherwise disposed in the brace device 272 such that the actuators 134 vibrate parts of the PHR device that are in contact with the body when worn on the subject. The PHR devices 270, 280, 290 prevent contractures by positioning the limb with the wrist 114 between a 120 degrees flexion to 80 degrees extension angle, while simultaneously providing haptic stimulation, which may include MusclePHR and/or TactilePHR. The PHR devices 270, 280, 290 also can keep the fingers 107 in less than 90 degrees of flexion. The PHR devices 270, 280 290 may be adjustable so that the angle of the joints can be adjusted for therapeutic benefit or comfort or based on the patient side or progress. Having the fingers 107 and wrist 114 within the given angles will also keep the muscles longer, which will increase receptor discharge in response to stimulation. The use of the PHR devices 270, 280, 290 having both a positioning brace 272 and haptic actuators 134 to provide PHR provides a device which is wearable, keeps the limb in an optimal position for comfort, provides stretch to prevent tendon shortening, increases receptor discharge, and which also prevents progression of contractures. Although some previous braces have contained stimulation for wound healing or bone growth or postsurgical analgesia, such contexts are quite different from spasticity and hypertonia. Such stimulation is typically electrical in nature. In addition, hypertonia bracing of the arm has never been combined with tactile stimulation or proprioceptive stimulation. Hypertonia bracing is often uncomfortable and difficult as the fingers and wrist try to contract and lose their positioning. The results of testing in three clinical trials indicate that such PHR stimulation can relieve hypertonia and thus may revolutionize positioning of the limb in hypertonia to improve comfort and add efficacy. The PHR devices 270, 280, 290 also differ from devices, like AMES (assisted movement with enhanced sensation) devices, which move the limbs, and therefore present a new, emerging paradigm to use PHR for hypertonia.

The PHRcounteract design may be utilized on any parts of the body by using a brace designed for the particular body parts and providing and positioning haptic actuators 134 at the appropriate location to apply PHR to treat symptoms of hypertonia, or other neurological dysfunction. For example, the PHRcounteract may be configured and designed for use with any suitable brace device, such as a wrist finger orthotic (WFO), a wrist hand orthotic (WHO), a wrist hand finger orthotic (WHFO), an ankle foot orthotic (AFO), splints, braces armatures, exoskeletons, etc.

### Others

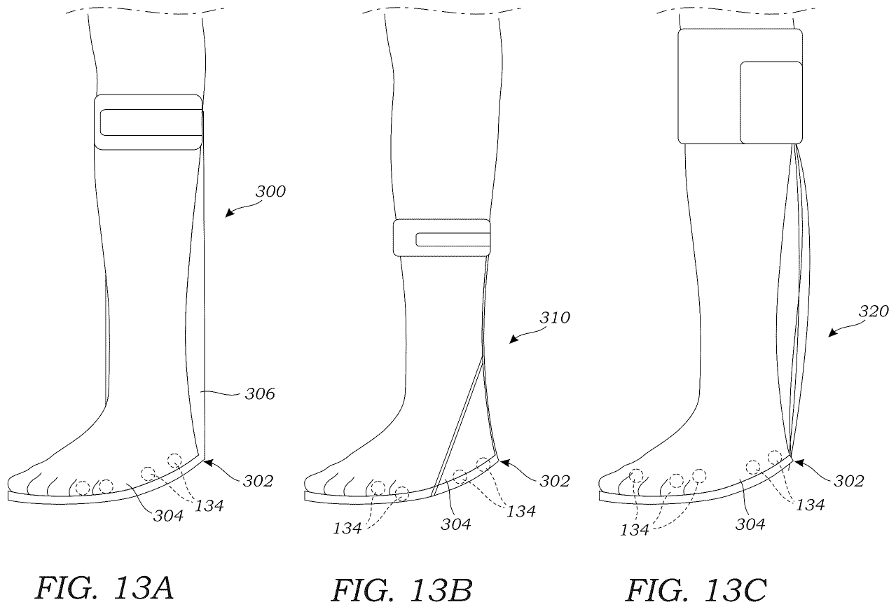

FIGS. 13A-13C illustrate several PHR devices 300, 310 and 320 for applying PHR stimulation to the plantar surface of the foot, with optional stimulation at the tibialis anterior, gastrocnemius, soleus or connected tendons or bones (also referred to as a PHRgrounded). The device tilts the foot near a 90-degree angle with an optional hinge 306 for flexibility, and prevents pronation and supination of the foot which may be common in lower-limb spastic hypertonia. The PHR devices 300, 310 and 320 are specially designed device with tactile and proprioceptive stimulation for neuromodulation and central change. The PHR devices 300, 310 and 320 d provide tested neuromodulatory input in a unique noninvasive format for the purpose of making the ankle and toes less stiff, spastic, hypertonic, weak, or numb, and may also prevent foot drop. Unlike normal casts, boots, and braces—PHR devices 300, 310 and 320 are designed for brain injury or spinal injury or disease which would cause the foot to contort, contract, or be limb or weak. The PHR devices 300, 310 and 320 encourage dorsoflexion, discourage toe contraction via neuromodulation alone, discourages ankle pronation or supination via stimulation.

The PHR devices 300, 310, 320 comprise a foot support device 302 configured to be worn on the foot 304 of the subject, and a plurality of haptic actuators 134 disposed on the foot support device 302 configured and positioned to apply PHR to the foot 304. The PHR devices 300, 310, 320 also have a controller 140 (not shown) operably coupled to the haptic actuators 134, same or similar to the PHR device 100. The PHR devices 270, 280, 290 may also include a fabric cover or other material covering the haptic actuators 134 such that the cover is between the actuators 134 and the skin of the subject during use.

The PHR devices 300, 310 and 320 are NOT balance feedback devices. They are for rehabilitation over time, not just of balance. Some devices are designed to provide music to the foot but these devices are usually embedded in shoes and are designed with a single speaker-like actuator. One can also apply closed-loop cues (such as a metronome for walking) or stimulation from shoe insoles. However, the PHR devices 300, 310 and 320 are unique because they are configured for people with impaired leg function, somatosensation, or spastic hypertonia. The PHR devices 300, 310 and 320 provide vibrotactile, not electrical stimulation, and is not in the form of an insole or shoe.

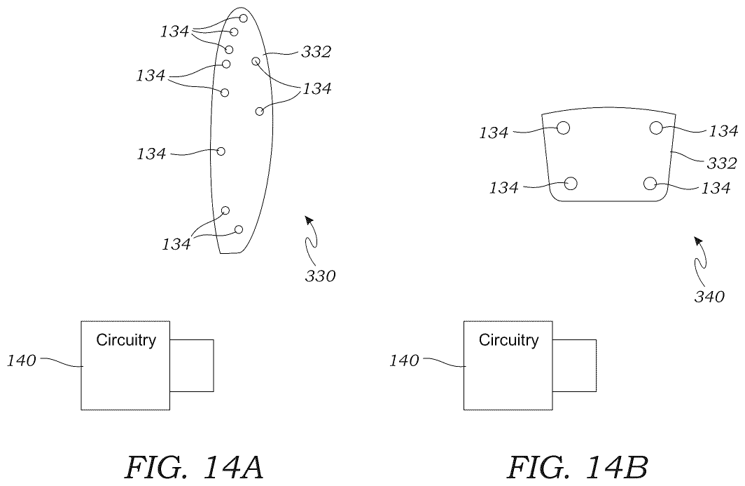

FIGS. 14A and 14B illustrate two PHR devices 330, 340, which are pad-like devices configured to be added onto any limb-mounted apparatus to apply PHR treatment to a particular part of the body (also referred to as PHRPadOn). The PHR devices 330, 340 may be a pad, individual motors and circuit box, a clip-on unit, etc. The PHR devices 330, 340 are simpler and less expensive to manufacture than the other PHR devices disclosed herein.in case a patient cannot afford the PHRgrounded or PHRcounteract. FIG. 13A depicts a PHR device 330 comprising a pad 332 for a foot, and a plurality of haptic actuators 134 disposed and positioned on the pad 332 to apply PHR to the regions of the body on which the PHR device 330 is mounted. FIG. 13B depicts a similar PHR device 340 for a hand, or any other suitable body area to which the PHR device 340 may be applied. The PHR devices 330, 340 also include a controller 140 (not shown) operably coupled to the haptic actuators 134, same or similar to the PHR device 100. The controllers 140 may include an attachment device 334 for attaching the controller 140 to an orthotic, splint, brace, robotic device, wearable device, armature, exoskeleton, etc.

PHR devices like PHR devices 330, 340 can be sized and shaped for any upper-limb or lower-limb mounted apparatus, including any orthotic, splint, brace, robotic device, wearable device, armature, exoskeleton, etc. Such PHR devices may be configured to not be mounted on the limb but instead are mounted on something that is mounted on the limb. Alternatively, the PHR devices can be designed to attach to the limb and then the limb is put into an apparatus/splint/shoe. The PHR device may be configured to apply any suitable combination of MusclePHR, TactilePHR or combination of MusclePHR+Tactile PHR. In other aspects, the actuators 134 may be enclosed in a flexible material like fabric or in a rigid material like plastic or a semirigid material like foam. The actuators 134 may be attached inside the plantar-facing side of a leg-mounted apparatus that does not have PHR capabilities, the straps, the support structures, or any part of the device so that the actuator add on is between the apparatus and the limb. The actuators 134 may be attached on a leg-mounted apparatus that does not have PHR capabilities not in contact with the limb, so that the actuators vibrate parts of the apparatus that are in contact with the limb. The actuators 134 may lay inside a leg-mounted apparatus that does not have PHR capabilities with no attachment mechanism. The actuators 134 may attach to a leg-mounted apparatus that does not have PHR capabilities using hook and look fasteners, adhesive, zipper, magnets, hinges, bands or any other suitable method. The controller 140 may attach to hook and loop fasteners or fabric portions of the apparatus using hook and loop fasteners, clip(s), magnets, zipper, adhesive, hinges, or any other method. The controller 140 may attach to rigid portions of the apparatus using hook and loop fasteners, clip(s), magnets, zipper, adhesive, hinges, or any other method. The actuators 134 may be attached inside the volar-facing side of an upper-limb apparatus, the straps, the support structures, or any part of the device so that the PHR device add on is between the upper-limb apparatus and the limb. The actuators 134 may be attached on the upper-limb apparatus not in contact with the limb, so that the actuators 134 vibrate parts of the PHR device (upper-limb apparatus) that are in contact with the limb. The actuators 134 may lay inside an upper-limb apparatus with no attachment mechanism. The actuators 134 may attach to the upper-limb apparatus using hook and loop fasteners, adhesive, zipper, magnets, hinges, bands or any other suitable method.

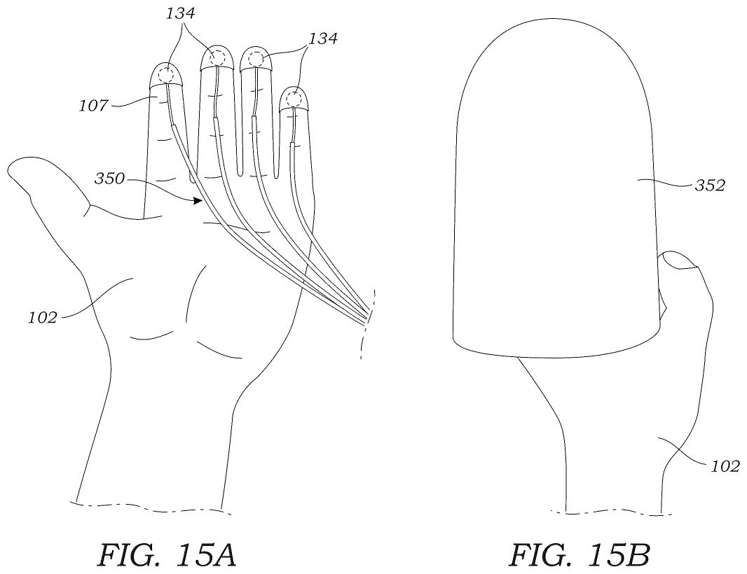

FIG. 15 illustrates a PHR device 350 for applying PHR to for stimulation in any retraining way or modulation applied, i.e. in conditions with low activity needing retraining like sensorimotor function after stroke or conditions with imbalanced excitatory drive like hypertonia of the fingertips top or bottom. The PHR device 350 is configured to apply PHR to the fingertips of a subject's hand 102. The PHR device 350 includes a plurality of haptic actuators 134 configured for placement on the fingertip of each finger 107. The PHR device 350 includes a controller operably coupled to the haptic actuators 134, same or similar to the PHR device 100. The PHR device 350 may also include a cover 352 for covering the haptic actuators 134 and the fingers 107 to protect the haptic actuators 134 during treatment. Accordingly, the PHR device 350 is configured to apply TactilePHR and/or MusclePHR to the fingertips using the haptic actuators 134 positioned on the fingertips.

The PHR devices disclosed herein, such as the PHR devices 330, 340, may also be used in combination with any powered or unpowered exoskeletons and robotic devices/actuating devices to provide a robotic PHR system (also referred to as PHRRobo) for applying PHR stimulation as described herein. Accordingly, the robotic PHR system can perform robotic (autonomous or semi-autonomous) physically assistive tasks while providing PHR treatment in the background.

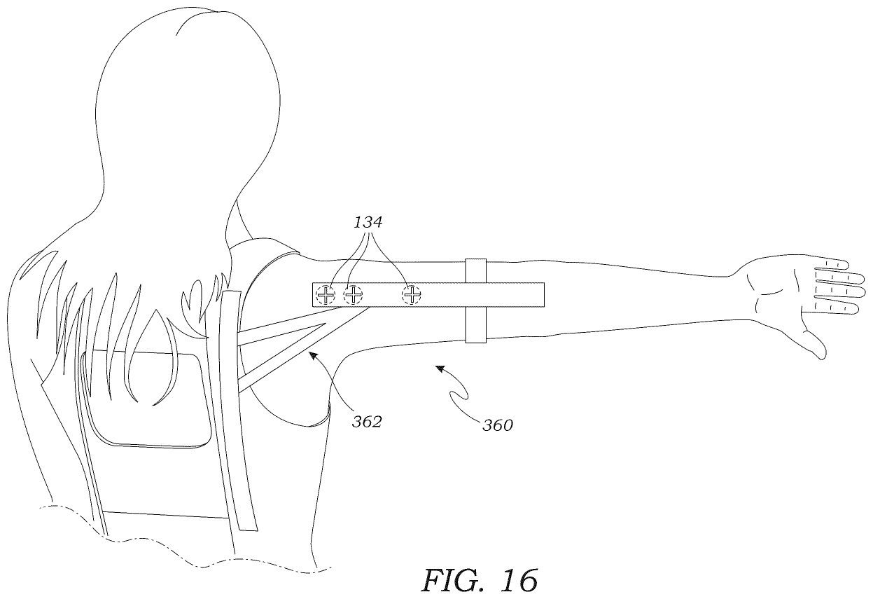

FIG. 16 illustrates a PHR device 360 which provides PHR while supporting or mechanically assisting the limb during movement, i.e. knee joint, or even arm abduction support. The PHR device 360 includes a motion assist device 362 which is configured to mechanically guide and/or assist the movement of a body part. The PHR device 36 also includes a plurality of haptic actuators 134 disposed on the motion assist device 362 configured and positioned to apply PHR to a particular treatment region. The use of PHR while moving using the motion assist device may reduce flexion synergy or spasticity or hypertonia so that abduction is easier, movement is easier, and assistive apparatuses are more effective.

Furthermore, any of the devices and/or methods disclosed herein may be used in combination with each other, and features, aspects and elements from various examples may be combined with any examples.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A system for passive haptic rehabilitation (PHR) which applies passive haptic stimulation to muscle of patient's body, comprising:
a wearable appliance configured to be worn on a patient's body and one or more haptic actuators disposed on the wearable appliance, the wearable appliance configured to be worn on a patient's body to position and retain the one or more haptic actuators proximate a body area to which muscle haptic stimulation is to be applied; and
a controller operably coupled to the one or more haptic actuators, the controller configured to control the operation of the one or more haptic actuators, including a frequency of vibration actuation of the haptic actuators;
wherein the system is configured to apply haptic stimulation at a frequency and an amplitude that stimulates the afferent receptors in the muscles of the body area.

2. The system of claim 1, wherein the wearable appliance is configured to be worn on the hand of the patient's body.

3. The system of claim 2, wherein the wearable appliance comprises:
a first strap configured to be fitted around the knuckles and the palm of a hand;
a second strap configured to be fitted around at least one of the wrist, forearm and anterior arm and positioned adjacent to the first strap.

4. The system of claim 3, wherein:
one or more of the haptic actuators are disposed on the first strap in a position of the knuckles when fitted on a hand; and
one or more the haptic actuators are disposed in a position of the palm when fitted on a hand.

5. The system of claim 1, wherein the wearable appliance comprises:
a glove having a dorsal portion configured to fit onto the dorsal part of a hand and a plurality of finger portions each connected the dorsal portion and configured to fit on fingers of a hand; and
wherein one or more of the haptic actuators are disposed on the one or more of the finger portions, and one or more of the haptic actuators are disposed on the dorsal portion.

6. The system of claim 5, wherein the glove further comprises:
a palm portion to which the finger portions are also connected; and
wherein one or more of the haptic actuators are disposed on the palm portion.

7. The system of claim 1, wherein the wearable appliance comprises a grip device configured to be gripped in a hand; and
wherein one or more of the haptic actuators are disposed on the grip device.

8. The system of claim 7, wherein the grip device is disposed on a strap configured to be worn on a hand, and the grip device is one of a ball or a bar.

9. The system of claim 1, wherein the wearable appliance comprises a hand orthotic brace device configured to be worn on a hand and wrist, the hand orthotic brace device configured to resist contractures of the hand, and to maintain the hand in a set posture; and
wherein one or more of the haptic actuators are disposed on the hand orthotic brace to apply muscle haptic stimulation to the forearm, and one or more of the haptic actuators are disposed on the hand orthotic brace to apply haptic stimulation to the hand.

10. The system of claim 1, wherein the wearable appliance comprises a foot orthotic brace device configured to be worn on a foot and lower leg, the foot orthotic brace device configured to maintain at least one of the foot, ankle, and toes in a set posture; and
wherein one or more of the haptic actuators are disposed on the foot orthotic brace to apply muscle haptic stimulation to the lower leg.

11. The system of claim 1, wherein the wearable appliance comprises a pad device configured to be attached to another wearable device configured to be worn on a patient's body; and
wherein one or more of the haptic actuators are disposed on the pad device.

12. The system of claim 1, wherein the controller and haptic actuators are configured to apply muscle haptic stimulation at a frequency from 40 Hz to 120 Hz.

13. The system of claim 1, wherein the controller and haptic actuators are configured to apply muscle haptic stimulation at an acceleration amplitude from 1.5 g to 4 g

14. The system of claim 1, wherein the controller and haptic actuators are configured to apply muscle haptic stimulation at a deformation amplitude from 0.3 mm to 3 mm.

15. The system of claim 1, wherein the one or more haptic actuators are configured to apply non-focal stimulation.

16. The system of claim 1, wherein each of the one or more haptic actuators are arranged to provide haptic stimulation in a respective stimulation zone.

17. The system of claim 16, wherein the respective stimulation zones for all of the haptic actuators are not overlapping.

18. The system of claim 16, wherein the respective stimulation zones for two or more of the haptic actuators are overlapping.

19. The system of claim 1, wherein the controller is configured to actuate the haptic actuators according to a predetermined on/off pattern.

20-21. (canceled)

22. A method of performing passive haptic rehabilitation (PHR) to treat a neurological dysfunction of a patient, comprising:
fitting a wearable passive haptic stimulation system onto a patient's body, with one or more haptic actuators of the wearable passive haptic stimulation system positioned proximate a body area to apply muscle haptic stimulation;
applying, for a treatment session, muscle haptic stimulation to muscle in a body area of a patient's body using the wearable passive haptic stimulation system at a frequency and an amplitude that stimulates the afferent receptors in the muscles of the body area; and
repeating the treatment session over a treatment period to achieve retraining, including new neurological connections providing long term improvement in the neurological dysfunction.

23-42. (canceled)
